(19) United States
(12) Patent Application Publication
(10) Pub. No.: US 2020/0153060 A1
(43) Pub. Date: May 14, 2020

(54) ACCUMULATOR ARRANGEMENT

(71) Applicant: Mahle International GmbH, Stuttgart (DE)

(72) Inventors: Ingo Haeusler, Esslingen (DE); Thomas Kalmbach, Stuttgart (DE); Christian Kern, Remseck (DE); Ruediger Knauss, Kernen I.r. (DE); Alireza Mirsadraee, Ludwigsburg (DE); Heiko Neff, Auenwald (DE); Peter Nowak, Stuttgart (DE); Markus Plandowski, Stuttgart (DE); Dennis Riegraf, Balingen (DE); Karl-Ulrich Schmid-Walderich, Tuebingen (DE); Mario Wallisch, Aichtal (DE)

(21) Appl. No.: 16/680,425

(22) Filed: Nov. 11, 2019

(30) Foreign Application Priority Data
Nov. 12, 2018 (DE) 10 2018 219 250.2

(51) Int. Cl. H01M 10/6557; H01M 10/613; H01M 10/625; H01M 2/10

(52) U.S. Cl. CPC H01M 10/6557; H01M 2/1077; H01M 10/625; H01M 10/613

(57) ABSTRACT

An accumulator arrangement may include a plurality of battery cells stacked in an X direction to form at least one battery block, a housing with at least one part interior in which the battery block may be arranged, and a cooling device for cooling the battery cells, a cooling fluid being flowable through the cooling device. The battery block may have first and second contact sides lying opposite one another in a Y direction, first and second support sides lying opposite one another in a Z direction, and two clamping sides lying opposite one another in the X direction. The battery block in the part interior may be able to be at least one of flowed around by the cooling fluid multilaterally and flowed through at least partially, so that the part interior forms a part of the cooling device through which the cooling fluid is flowable.

### CROSS-REFERENCE TO RELATED APPLICATIONS

This application claims priority to German Patent Application No. DE 10 2018 219 250.2, filed on Nov. 12, 2018, the contents of which are hereby incorporated by reference in its entirety.

### TECHNICAL FIELD

The invention relates to an accumulator arrangement for a hybrid or electric vehicle.

### BACKGROUND

Accumulator arrangements for hybrid or electric vehicles are already known from the prior art. Here, several battery cells are accommodated in battery modules and are arranged in a housing. To receive their function, the battery cells are temperature-controlled here. In particular in accumulator arrangements with a high power density and a required fast charging capability, an efficient cooling is indispensable. Accumulator arrangements with a direct air cooling are known from WO 2017/026312 A1. Here, the battery cells are flowed around directly by the air and are thereby cooled. As the air has a comparatively lower heat absorption capacity, a high volume flow must be directed against contact surfaces. The air is distributed here in a random manner in the housing or is directed in a so-called circular path around the battery block. The high volume flow also requires greater intermediate spaces in the housing, which are a disadvantage with regard to the installation space requirement for the accumulator arrangement. The discharged amount of heat remains small here, so that an efficient cooling with a liquid coolant is necessary. Usually, for this, the battery cells are cooled in the battery module by cooling plates which are in a heat-transferring contact with the individual battery cells. The cooling plates are flowed through by the liquid coolant and are thereby cooled. Disadvantageously, the concept of a direct cooling of the battery cells is not readily transferable to a liquid coolant and is hitherto realized only for individual regions of the battery cells—such as for example for current diverters of the battery cells.

It is therefore the object of the invention to indicate, for an accumulator arrangement of the generic type, an improved or at least alternative embodiment, in which the described disadvantages are overcome.

This problem is solved according to the invention by the subject of the independent claims. Advantageous embodiments are the subject of the dependent claims.

### SUMMARY

The present invention is based on the general idea of achieving an efficient and uniform cooling in an accumulator arrangement by a direct action upon the battery cells by a cooling fluid. An accumulator arrangement is provided for a hybrid or electric vehicle and has several battery cells, which are stacked in an X direction to form at least one battery block. The battery block then has a first contact side and a second contact side, which lie opposite one another in a Y direction running perpendicularly to the X direction. Furthermore, the battery block has a first support side and a second support side, which lie opposite one another in a Z direction running perpendicularly to the X direction and perpendicularly to the Y direction. The battery block has, furthermore, two clamping sides lying opposite one another in the X direction. The accumulator arrangement has, furthermore, a housing with at least one part interior, in which the at least one battery block is arranged. The accumulator arrangement has, in addition, a cooling device, able to be flowed through by a cooling fluid, for cooling the battery cells in the at least one battery block. According to the invention, the at least one battery block is able to be flowed around in the respective part interior multilaterally by the cooling fluid or is able to be flowed around multilaterally by the cooling fluid and is able to be flowed through at least partially, so that the part interior forms a part of the cooling device which is able to be flowed through by the cooling fluid.

The at least one battery block is arranged in the part interior of the housing, wherein a wall of the housing, delimiting the part interior, and the at least one battery block and its battery cells are acted upon directly by the cooling fluid within the part interior. Thereby, the at least one battery block can be cooled efficiently and multilaterally. Preferably, the at least one battery block is acted upon by the cooling fluid in the part interior at least on four sides transversely to the X direction. Expediently, the cooling fluid is dielectric, so that the function of the at least one battery block, which is able to be flowed around and flowed through, is in no way impaired. By the direct action by the cooling fluid upon the at least one battery block and its battery cells, the individual battery cells can be cooled efficiently and uniformly.

In a further development of the accumulator arrangement, provision is made that the cooling device has a distributor and a collector. The distributor and the collector are open from the exterior into the part interior, so that the cooling fluid can be fed through the distributor into the part interior and can be discharged through the collector out from the part interior. Through the distributor and the collector, the cooling fluid can be distributed uniformly in the part interior, whereby an almost uniform cooling of the battery cells is made possible. In addition, the distributor and the collector in the part interior can extend in X direction along the at least one battery block. The main fluid flow of the cooling fluid is then aligned transversely to the X direction. In this way, the individual battery cells of the at least one battery block are flowed around by the cooling fluid at least on one side transversely to the X direction, and are cooled efficiently.

Advantageously, provision can be made that the distributor is formed by a distribution channel and the collector is formed by a collection channel. The distribution channel and the collection channel are then opened respectively into the part interior via several fluid openings. Preferably, the distribution channel and the collection channel are formed respectively in a wall of the housing which delimits the part interior on one side towards the exterior and for example faces the respective contact side of the battery block. The fluid openings than expediently pass through the respective wall. The fluid openings can be distributed uniformly in the distribution channel in X direction, so that the cooling fluid exits out from the distribution channel distributed uniformly in X direction. In particular, the cooling fluid can then exit to all battery cells of the at least one battery block in an adjacent manner, so that the battery cells can be efficiently cooled irrespective of their position in the battery block. Accordingly, the fluid openings of the collection channel can enable a uniform discharging of the cooling fluid out from the part interior. In the respective part interior, thereby a uniform flow and a uniform distribution of the temperature can be achieved around the at least one battery block in X direction.

In an advantageous embodiment of the accumulator arrangement, provision can be made that between the distributor and the collector a first flow path is provided for a first part flow of the cooling fluid and a second flow path is provided for a second part flow of the cooling fluid. Here, the first flow path and the second flow path direct the respective part flows contrary to one another around the battery block transversely to the X direction. Advantageously, provision can be made in addition that the distributor is arranged adjacent to a first edge of the first contact side and the second support side, and the collector is arranged adjacent to a second edge of the second contact side and the first support side. The first edge is defined here by a straight line or by a region, at which the first contact side and the second support side adjoin one another and form a right-angled or a rounded corner region of the battery block. The second edge is defined accordingly by a straight line or by a region, at which the second contact side and the first support side adjoin one another and form a right-angled or a rounded corner region of the battery block. The first flow path then leads from the first edge at the first contact side to the first support side; at the first support side to the second edge and further to the collector. The second flow path then leads from the first edge at the second support side to the second contact side; at the second contact side to the second edge and further to the collector.

The two edges are aligned here in X direction of the at least one battery block, and the two flow paths direct the respective part flows transversely to the X direction around the at least one battery block. In particular, the first part flow flows in the part interior from the first edge at the first contact side in Z direction—or contrary thereto—and then at the first support side in Y direction—or contrary thereto—to the second edge. The second part flow then flows in the part interior from the first edge at the second support side in Y direction—or contrary thereto—and then at the second contact side in Z direction—or contrary thereto—to the second edge. In other words, the first part flow and the second part flow run around the at least one battery block respectively on two sides and contrary to one another, so that the at least one battery block is flowed around on four sides in total transversely to the X direction. The first flow path and the second flow path are preferably of equal length and the part flows preferably have an identical volume flow and a similar temperature. The two part flows can thereby receive or emit an identical amount of heat in the part interior, so that the individual battery cells which are flowed around are cooled uniformly and efficiently in the at least one battery block. In particular, thereby an almost uniform distribution of the temperature can be achieved around the at least one battery block in X direction.

In a further development of the accumulator arrangement, provision is made that between the respective battery cells in the battery block several cell holders, with respectively two opposite support collars, are stacked. Here, the respective support collars project from the respective adjacent battery cells in Z direction and extend on the respective support sides in Y direction. Between the adjacent support collars and the respective battery cells, stacked therebetween, two opposite part channels are then respectively formed within the part interior, which part channels extend at the respective support sides in Y direction and are able to be flowed through by the cooling fluid. The respective support collars can be L-shaped or T-shaped, for example. The cell holder is preferably formed here from a heat-conducting material, in order to be able to feed the heat, generated in the battery cells, to the support collars and to discharge it from there to the cooling fluid. The respective part channels are then delimited in Z direction by the support collars and side faces of the respective battery cells and in X direction by the wall of the cell holders. The number of part channels corresponds here to n times or 1/n times the number of battery cells. Through the part channels at the support sides of the at least one battery module, the cooling fluid can be distributed uniformly and a transverse flow at the support sides can be advantageously prevented. Thereby, the individual battery cells in the at least one battery block can be cooled uniformly at the support sides.

When the cooling fluid is divided into two part flows by the distributor to the collector, as described above, the first flow path and the second flow path on the respective support side of the battery block can lead through the part channels. Accordingly, the first part flow flows through the part channels at the first support side and the second part flow flows through the part channels at the second support side. On entry of the part flows into the part channels, these are divided into several parallel flows and, after exiting of the parallel flows from the part channels, these combine again to the respective part flow. The first part flow and the second part flow preferably have an identical volume flow and a similar temperature. After the dividing of the respective part flows into the parallel flows, these preferably have an identical volume flow and a similar temperature. The parallel flows can thereby receive or emit an almost identical amount of heat at the respective support side, so that the individual battery cells are cooled uniformly and efficiently at the support sides of the at least one battery block.

In a further development of the accumulator arrangement, provision is made that the respective battery cells have respectively two opposite current diverters which, at the opposite contact sides of the battery block, extend from the battery cells in Y direction. The current diverters of the battery cells are electrically contacted individually or in groups with one another at the respective contact sides, so that the battery cells in the battery block are connected serially and/or parallel to one another. In order to intensify the cooling of the individual battery cells at the respective contact sides of the battery block, at the respective contact side of the battery block at least one cooling plate of a heat-conducting material can be secured in a heat-transferring manner on the current diverters and so as to be able to be flowed around by the cooling fluid. The heat-conducting plate is then flowed around by the cooling fluid and is acted upon directly, so that the heat generated in the current diverters can be discharged effectively via the cooling plate.

To sum up, the at least one battery block in the accumulator arrangement according to the invention is flowed around directly by the cooling fluid, or is flowed around and flowed through, and is thereby able to be cooled effectively and uniformly.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically,

FIG. 1 a sectional view of an accumulator arrangement according to the invention;

FIG. 2 an individual battery cell in the accumulator arrangement according to the invention;

FIG. 3 a sectional view of a battery block in the accumulator arrangement according to the invention;

FIG. 4 a view of the battery block, which is flowed around and partially flowed through, in the accumulator arrangement according to the invention.

### DETAILED DESCRIPTION

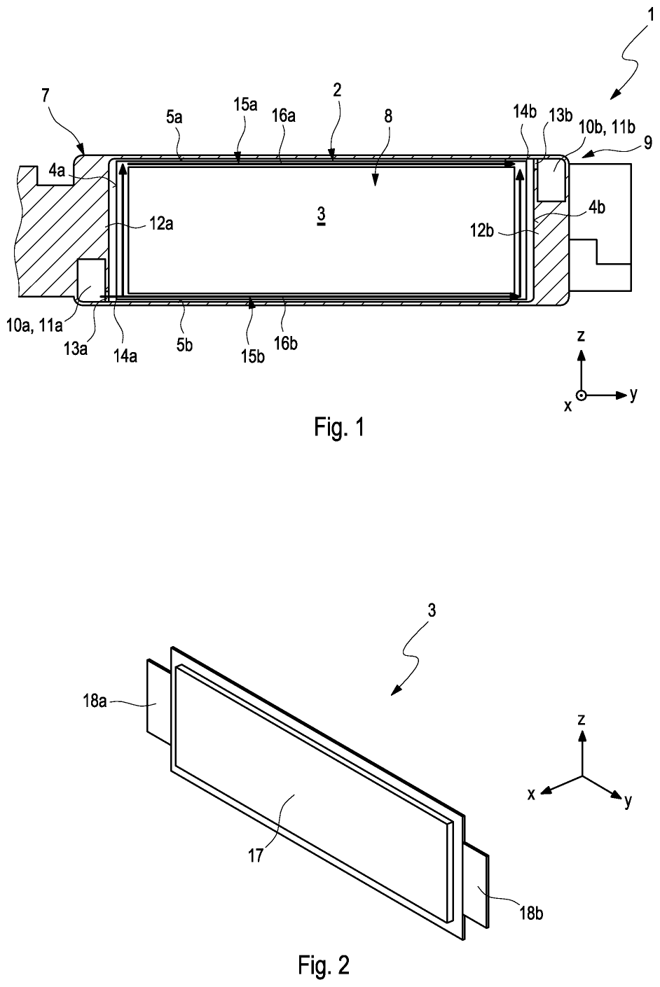

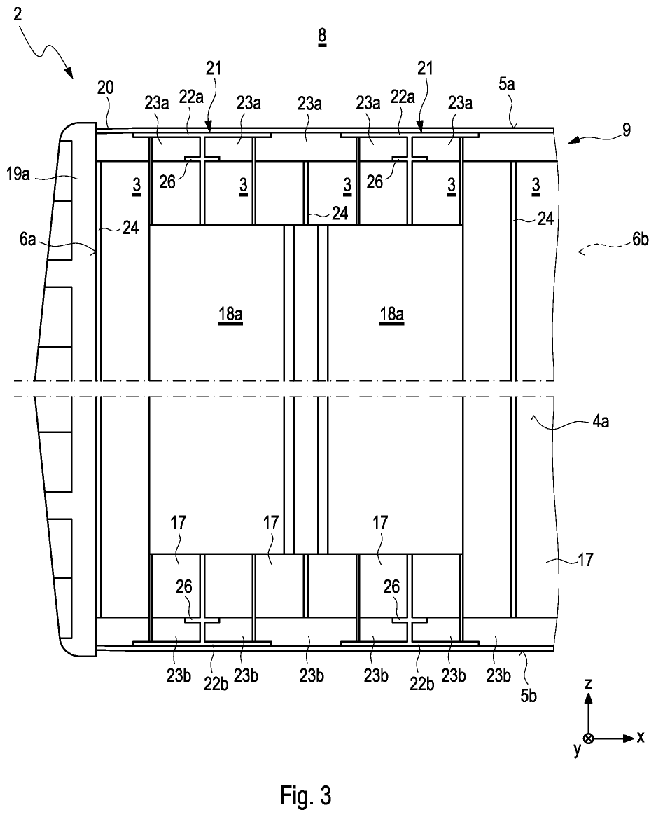

FIG. 1 shows a sectional view of an accumulator arrangement 1 according to the invention, for a hybrid or electric vehicle. The accumulator arrangement 1 has a battery block 2 of several battery cells 3, which are stacked with one another in an X direction. The battery block 2 then has a first contact side 4a and a second contact side 4b; a first support side 5a and a second support side 5b; and two clamping sides 6a and 6b—see FIG. 3 in this respect. The contact sides 4a and 4b are arranged opposite one another in a Y direction running perpendicularly to the X direction, and the support sides 5a and 5b are arranged opposite one another in a Z direction running perpendicularly to the X direction and perpendicularly to the Y direction. The clamping sides 6a and 6b lie opposite one another in X direction. The accumulator arrangement 1 has, in addition, a housing 7 with a part interior 8, in which the battery block 2 is arranged. The battery cells 3 in the accumulator arrangement 1 are able to be cooled by a cooling device 9, able to be flowed through by a cooling fluid, which cooling device comprises a distributor 10a, a collector 10b and the part interior 8. The battery block 2 is able to be flowed around multilaterally in the part interior 8 by the cooling fluid and is arranged so as to be able to be flowed through at least partially, and is acted upon directly with the cooling fluid. The cooling fluid is expediently dielectric, so that the function of the battery block 2 is in no way impaired.

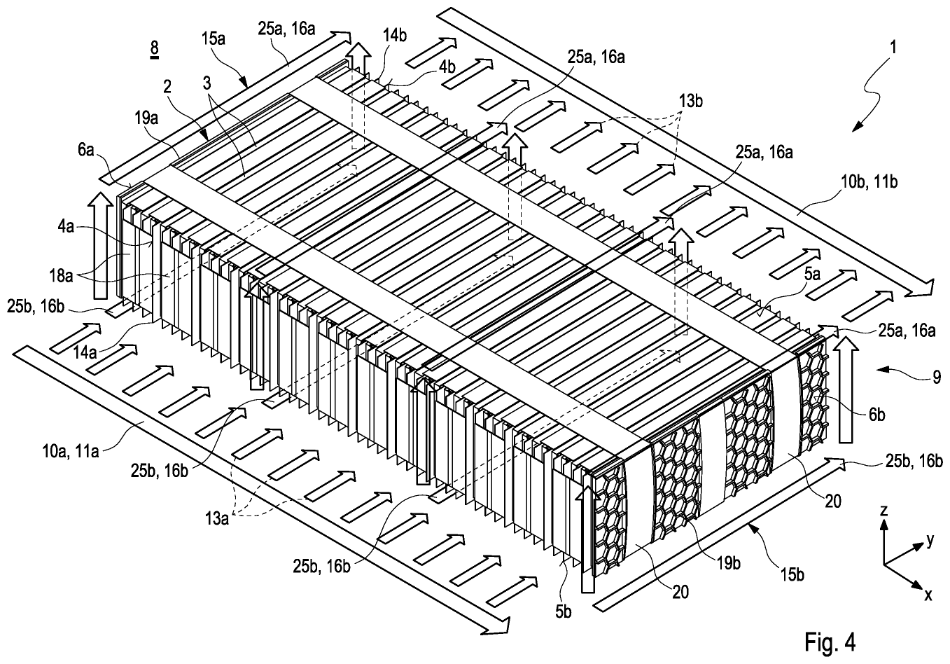

The part interior 8 of the housing 7 is sealed toward the exterior, and the cooling fluid is fed from the exterior into the part interior 8 through the distributor 10a, and is discharged from the part interior 8 towards the exterior through the collector 10b. In this example embodiment, the distributor 10a is formed by a distribution channel 11a and the collector 10b is formed by a collection channel 11b. The distribution channel 11a and the collection channel 11b are formed integrally respectively in a wall 12a and 12b of the housing 7 and are aligned in X direction in an adjacent manner to the battery block 2. The respective wall 12a and 12b delimits here the part interior 8 to one side toward the exterior and is arranged facing the respective contact side 4a and 4b of the battery block 2. The distribution channel 11a and the collection channel 11b are respectively opened into the part interior 8 via several fluid openings 13a and 13b. The fluid openings 13a and 13b are distributed uniformly in the distribution channel 11a and in the collection channel 11b in X direction of the battery block 2, as is explained further below with the aid of FIG. 4.

The distributor 10a or respectively the distribution channel 11a is arranged adjacent to a first edge 14a, which is formed at the first contact side 4a and at the second support side 5b. The collector 10b or respectively the collection channel 11b is arranged adjacent to a second edge 14b, which is formed at the second contact side 4b and at the first support side 5a. Thereby, in the part interior 8 a first flow path 15a is provided for a first part flow 16a of the cooling fluid, and a second flow path 15b is provided for a second part flow 16b of the cooling fluid. The two edges 14a and 14b are aligned in X direction, and the two flow paths 15a and 15b direct the respective part flows 16a and 16b in a contrary manner transversely to the X direction around the battery block 2. The first part flow 16a flows in the part interior 8 from the first edge 14a at the first contact side 4a in Z direction and then at the support side 5a in Y direction to the second edge 14b. The second part flow 16b then flows in the part interior 8 from the first edge 14a at the second support side 5b in Y direction and then at the second contact side 4b in Z direction to the second edge 14b. Thereby, the first part flow 16a and the second part flow 16b run around the battery block 2 respectively on two sides and contrary to one another, so that the battery block 2 is flowed around on four sides in total transversely to the X direction and is thereby effectively cooled.

It shall be understood that in the accumulator arrangement 1 several battery blocks 2 are arranged in several part interiors 8 and can be cooled as described above. Furthermore, it is conceivable that several battery blocks 2 are also arranged in the individual part interiors 8. The respective distributors 10a and the respective collectors 10b of the individual part interiors 8 can then be fluidically connected with one another in the cooling device 9 in a suitable manner, in order to enable the flowing through of the several part interiors 8.

FIG. 2 shows the battery cell 3, as it is aligned in the battery block 2. The battery cell 3 which is shown here is a pouch cell and has a deformable body 17 and two opposite current diverters 18a and 18b. The current diverters 18a and 18b project from the body 17 and extend in the battery block 2 at the respective contact sides 4a and 4b in Y direction.

FIG. 3 now shows a sectional view of the battery block 2 with the several battery cells 3 stacked against one another. As is visible here, the individual battery cells 3 are clamped with one another by means of two opposite clamping plates 19a and 19b—only one visible here—and two tension belts 20—only one visible here—in X direction. The clamping plates 19a and 19b lie here at the clamping sides 6a and 6b of the battery block 2 against the last battery cells 3. The current diverters 18a and 18b are electrically contacted with one another in groups at the respective contact side 4a and 4b, so that the battery cells 3 in the battery block 2 are connected serially and/or parallel to one another. Between the individual battery cells 3 and against the clamping plates 19a and 19b, in addition elastic inserts 24 are arranged, which enable a clamping of the battery cells 2 in X direction.

In addition, several cell holders 21 with respectively two opposite T-shaped support collars 22a and 22b are stacked between the respective battery cells 3. Here, the inserts 24 and the cell holders 21 alternate in the batter block 2 between the battery cells 3 in X direction. The respective support collars 22a and 22b project from the respective adjacent battery cells 3 in Z direction and extend at the respective support side 5a and 5b in Y direction. Between the adjacent support collars 22a and 22b and the respective battery cells 3 stacked therebetween, two opposite part channels 23a and 23b are then respectively formed. The part channels 23a and 23b extend at the respective support side 5a and 5b in Y direction and are able to be flowed through by the cooling fluid. The part channels 23a form here a part of the first flow path 15a, and the part channels 23b form a part of the second flow path 15b. At the respective cell holders 21 in addition holding collars 26 are formed, which fix the battery cells 3 in the battery block 2 in Z direction.

FIG. 4 shows a view of the flowed-around battery block 2 in the accumulator arrangement 1. The cooling fluid flows in from the exterior in the distribution channel 11a in X direction and is fed via the fluid openings 13a into the part interior 8. The cooling fluid is discharged out from the part interior 8 via the fluid openings 13b and flows into the collection channel 11b in X direction towards the exterior. Here, the fluid openings 13a and 13b are distributed uniformly in the distribution channel 11a and in the collection channel 11b in X direction of the battery block 2, so that the cooling fluid exits from the distribution channel 11a in X direction in a uniformly distributed manner. After the exiting of the cooling fluid from the distribution channel 11a at the first edge 14a, the cooling fluid divides into the first part flow 16a and into the second part flow 16b. The first part flow 16a then flows—as already explained with the aid of FIG. 1—from the first edge 14a at the first contact side 4a in Z direction and then at the first support side 5a in Y direction to the second edge 14b. At the first support side 5a, the first part flow 16a is divided into several first parallel flows 25a, wherein each of the respective parallel flows 25a is assigned to one of the respective part channels 23a at the first support side 5a. The second part flow 16b flows—as already explained with the aid of FIG. 1—from the first edge 14a at the second support side 5b in Y direction to the second contact side 4b. Here, the second part flow 16b at the second support side 5b is divided into several parallel flows 25b. Each of the respective parallel flows 25b is assigned here to one of the respective part channels 23b at the second support side 5b. After the flowing through of the part channels 23b, the second part flow flows at the second contact side 4b in Z direction to the second edge 14b. At the second edge 11b, the two part flows 16a and 16b flow together and flow out from the part interior 8 via the collection channel 11b. The flow of the cooling fluid is indicated by arrows in FIG. 4, wherein here for clarity the division into the part flows 16a and 16b is indicated by way of example at a total of three locations. It shall be understood that the two part flows 16a and 16b flow around the contact sides 4a and 4b and the support sides 5a and 5b almost over the entire surface.

The first part flow 16a and the second part flow 16b preferably have here an identical volume flow and a similar temperature. After the dividing of the part flows 16a and 16b into the parallel flows 25a and 25b, the parallel flows 25a and 25b preferably have an identical volume flow and a similar temperature. In the part interior 8, a uniform flow and a uniform distribution of the temperature can thereby be achieved in X direction around the battery block 2. The battery cells 3 are thereby cooled uniformly and efficiently in the battery block 2 irrespective of their position in X direction.

1. An accumulator arrangement for a hybrid or electric vehicle, comprising:
a plurality of battery cells, which are stacked in an X direction to form at least one battery block;
a housing with at least one part interior in which the at least one battery block is arranged; and
a cooling device for cooling the battery cells, a cooling fluid being flowable through the cooling device;
wherein the battery block has a first contact side and a second contact side, which lie opposite one another in a Y direction running perpendicularly to the X direction;
wherein the battery block has a first support side and a second support side, which lie opposite one another in a Z direction running perpendicularly to the X direction and perpendicularly to the Y direction;
wherein the battery block has two clamping sides lying opposite one another in the X direction; and
wherein the at least one battery block in the respective part interior is able to be at least one of flowed around by the cooling fluid multilaterally and flowed through at least partially, so that the respective part interior forms a part of the cooling device through which the cooling fluid is flowable.

2. The accumulator arrangement according to claim 1, wherein the cooling device has a distributor and a collector, which are open from outside the housing into the part interior, so that the cooling fluid is feedable through the distributor into the part interior and dischargeable through the collector out from the part interior.

3. The accumulator arrangement according to claim 2, wherein the distributor and the collector in the part interior extend in the X direction respectively along the at least one battery block, so that the cooling fluid is fed in a distributed manner in the X direction into the part interior and is discharged in a distributed manner in the X direction through the collector out from the part interior and thereby the main fluid flow of the cooling fluid around the battery block is aligned transversely to the X direction.

4. The accumulator arrangement according to claim 2, wherein:
the distributor is formed by a distribution channel and the collector is formed by a collection channel in a wall of the housing; and
the distribution channel and the collection channel are open respectively via a plurality of fluid openings into the part interior.

5. The accumulator arrangement according to claim 2, wherein:
a first flow path is provided between the distributor and the collector for a first part flow of the cooling fluid, and a second flow path is provided for a second part flow of the cooling fluid; and
the first flow path and the second flow path direct the respective part flows in opposing directions around the battery block transversely to the X direction.

6. The accumulator arrangement according to claim 5, wherein:
the distributor is arranged adjacent to a first edge of the first contact side and the second support side, and the collector is arranged adjacent to a second edge of the second contact side and the first support side; and
the first flow path leads from the first edge at the first contact side to the first support side at the first support side to the second edge and further to the collector, and the second flow path leads from the first edge at the second support side to the second contact side at the second contact side to the second edge and further to the collector.

7. The accumulator arrangement according to claim 1, further comprising:
a plurality of cell holders that each has two opposite support collars and that are stacked between adjacent battery cells, wherein each support collar projects from the respective adjacent battery cells in the Z direction and extends at a respective support side in the Y direction; and
two opposite part channels are formed within the part interior between adjacent support collars and the respective adjacent battery cells stacked therebetween, which part channels extend at the respective support sides in the Y direction and are able to be flowed through by the cooling fluid.

8. The accumulator arrangement according to claim 7, wherein:
a first flow path is provided between the distributor and the collector for a first part flow of the cooling fluid, and a second flow path is provided for a second part flow of the cooling fluid;
the first flow path and the second flow path direct the respective part flows in opposing directions around the battery block transversely to the X direction; and
the first flow path and the second flow path lead through the part channels at the respective support side of the battery block.

9. The accumulator arrangement according to claim 1, wherein:
each battery cell has two current diverters lying opposite one another, which, at opposite contact sides of the battery block extend in the Y direction from the battery cell; and
the current diverters are electrically contacted at the respective contact sites individually or in groups with one another, so that the battery cells in the battery block are connected at least one of serially and parallel to one another.

10. The accumulator arrangement according to claim 9, wherein, at each contact side of the battery block, at least one cooling plate of a heat-conducting material is fixed to the current diverters in a heat-transferring manner and so as to be able to be flowed around by the cooling fluid.

11. The accumulator arrangement according to claim 3, wherein:
the distributor is formed by a distribution channel and the collector is formed by a collection channel in a wall of the housing; and
the distribution channel and the collection channel are open respectively via a plurality of fluid openings into the part interior.

12. The accumulator arrangement according to claim 3, wherein:
a first flow path is provided between the distributor and the collector for a first part flow of the cooling fluid, and a second flow path is provided for a second part flow of the cooling fluid; and
the first flow path and the second flow path direct the respective part flows in opposing directions around the battery block transversely to the X direction.

13. The accumulator arrangement according to claim 12, wherein:
the distributor is arranged adjacent to a first edge of the first contact side and the second support side, and the collector is arranged adjacent to a second edge of the second contact side and the first support side; and
the first flow path leads from the first edge at the first contact side to the first support side at the first support side to the second edge and further to the collector, and the second flow path leads from the first edge at the second support side to the second contact side at the second contact side to the second edge and further to the collector.

14. The accumulator arrangement according to claim 2, further comprising:
a plurality of cell holders that each has two opposite support collars and that are stacked between adjacent battery cells, wherein each support collar projects from the respective adjacent battery cells in the Z direction and extends at a respective support side in the Y direction; and
two opposite part channels formed within the part interior between adjacent support collars and the respective adjacent battery cells stacked therebetween, which part channels extend at the respective support sides in the Y direction and are able to be flowed through by the cooling fluid.

15. The accumulator arrangement according to claim 14, wherein:
a first flow path is provided between the distributor and the collector for a first part flow of the cooling fluid, and a second flow path is provided for a second part flow of the cooling fluid;
the first flow path and the second flow path direct the respective part flows in opposing directions around the battery block transversely to the X direction; and
the first flow path and the second flow path lead through the part channels at the respective support side of the battery block.

16. The accumulator arrangement according to claim 2, wherein:
each battery cell has two current diverters lying opposite one another, which, at opposite contact sides of the battery block extend in the Y direction from the battery cell; and
the current diverters are electrically contacted at the respective contact sites individually or in groups with one another, so that the battery cells in the battery block are connected at least one of serially and parallel to one another.

17. The accumulator arrangement according to claim 16, wherein, at each contact side of the battery block, at least one cooling plate of a heat-conducting material is fixed to the current diverters in a heat-transferring manner and so as to be able to be flowed around by the cooling fluid.

18. An accumulator arrangement for a hybrid or electric vehicle, comprising:
a plurality of battery cells, which are stacked in an X direction to form at least one battery block having:
a first contact side and a second contact side, which lie opposite one another in a Y direction running perpendicularly to the X direction;
a first support side and a second support side, which lie opposite one another in a Z direction running perpendicularly to the X direction and perpendicularly to the Y direction; and
two clamping sides lying opposite one another in the X direction;
a housing with at least one part interior in which the at least one battery block is arranged;
a cooling device for cooling the battery cells, a cooling fluid being flowable through the cooling device, the cooling device having a distributor and a collector, which are open from outside the housing into the part interior, so that the cooling fluid is feedable through the distributor into the part interior and dischargeable through the collector out from the part interior; and
a plurality of cell holders that each has two opposite support collars and that are stacked between adjacent battery cells, wherein each support collar projects from the respective adjacent battery cells in the Z direction and extends at a respective support side in the Y direction;
wherein the at least one battery block in the respective part interior is able to be at least one of flowed around by the cooling fluid multilaterally and flowed through at least partially, so that the respective part interior forms a part of the cooling device through which the cooling fluid is flowable.

19. The accumulator arrangement according to claim 18, wherein:
the distributor is formed by a distribution channel and the collector is formed by a collection channel in a wall of the housing; and
the distribution channel and the collection channel are open respectively via a plurality of fluid openings into the part interior.

20. The accumulator arrangement according to claim 18, wherein:
a first flow path is provided between the distributor and the collector for a first part flow of the cooling fluid, and a second flow path is provided for a second part flow of the cooling fluid; and
the first flow path and the second flow path direct the respective part flows in opposing directions around the battery block transversely to the X direction.
